(19) United States
(12) Patent Application Publication
(10) Pub. No.: US 2020/0017658 A1
(43) Pub. Date: Jan. 16, 2020

(54) GERM-REPELLENT ELASTOMER

(71) Applicant: Nano and Advanced Materials Institute Limited, Hong Kong (HK)

(72) Inventors: Xianqiao LIU, Hong Kong (HK); Michael Kwun Fung LO, Hong Kong (HK); Chen CHEN, Hong Kong (HK); Deryck Hin Yeung LI, Hong Kong (HK); Connie Sau Kuen KWOK, Hong Kong (HK)

(21) Appl. No.: 16/406,012

(22) Filed: May 8, 2019

Related U.S. Application Data
(63) Continuation-in-part of application No. 16/032,049, filed on Jul. 10, 2018.
Application No. 16/032,049 is a continuation-in-part of application No. 16/032,052, filed on Jul. 10, 2018.

(51) Int. Cl. C08K 5/29; C08K 5/11; C08K 5/06; C08J 3/20

(52) U.S. Cl. CPC C08K 5/29; C08K 5/11; C08J 2353/00; C08J 3/203; C08J 2375/04; C08K 5/06

(57) ABSTRACT

The present invention provides a germ-repellent elastomer comprising: a base polymer selected from latex, synthetic rubber, thermoplastic elastomers, or copolymers or mixtures thereof; and at least one germ-repelling modifier selected from one or more polyethoxylated non-ionic surfactants such that a highly hydrophilic moiety is imparted from the at least one germ-repelling modifier to the base polymer either by physical or reaction extrusion.

### CROSS-REFERENCE TO RELATED APPLICATIONS

The present application is a continuation-in-part of U.S. Non-Provisional patent application Ser. No. 16/032,049 filed Jul. 10, 2018, and is also a continuation-in-part of U.S. Non-Provisional patent application Ser. No. 16/032,052 filed Jul. 10, 2018, and the disclosures of which are incorporated herein by reference in their entirety.

### FIELD OF INVENTION

The present invention provides a germ-repellent elastomer and an article containing thereof.

### BACKGROUND

Elastomers are soft, flexible and versatile plastics for ranges of applications such as seals, molded flexible parts, cooking utensils and shoes soles. One of the elastomers is thermoplastic elastomers (TPE) which is a class of copolymers that gives both the thermoplastics and elastomeric characteristics. The benefit of TPE is its ability to elongate and return to its near original form, providing longer lifetime and better physical range than other materials. Compare to thermoset, it crosslinks with structures which provide flexible properties. TPE also takes advantage of weak molecular interactions (Van der Waal, hydrogen bonding or ionic interactions) amongst chemical groups to stabilize the shape of the molded elastomers.

Conventionally, antimicrobial agents are typically added to the plastics for antibacterial capability, especially for food contact products. However, this bears the risk to have the potentially harmful biocidal contents leaching into foodstuffs. Moreover, the slow-release of biocides that kills bacteria, potentially lead to the evolution of drug-resistant bacteria.

### SUMMARY OF INVENTION

In a first aspect of the present invention, there is provided a germ-repellent elastomer comprising a base polymer selected from latex, synthetic rubber, thermoplastic elastomers, or copolymers or mixtures thereof; and at least one germ-repelling modifier selected from one or more polyethoxylated non-ionic surfactants such that a highly hydrophilic moiety is imparted from the at least one germ-repelling modifier to the base polymer either by physical or reaction extrusion.

In a first embodiment of the first aspect of the present invention, there is provided a germ-repellent elastomer wherein the base polymer is thermoplastics elastomers.

In a second embodiment of the first aspect of the present invention, there is provided a germ-repellent elastomer wherein the base polymer is thermoplastics polyurethane.

In a third embodiment of the first aspect of the present invention, there is provided a germ-repellent elastomer wherein the base polymer is styrene ethylene butylene styrene.

In a forth embodiment of the first aspect of the present invention, there is provided a germ-repellent elastomer wherein the base polymer is liquid silicon rubber.

In a fifth embodiment of the first aspect of the present invention, there is provided a germ-repellent elastomer wherein the base polymer is high consistency rubber.

In a sixth embodiment, the one or more polyethoxylated non-ionic surfactants is/are selected from the group consisting of polyethylene glycol, alcohol ethoxylate, isocyanate, allyoxy group, siloxane, polyether modified silicone, polysorbates, and any derviatives, copolymers, or mixtures thereof.

In an seventh embodiment, each of the polyethoxylated non-ionic surfactants has a hydrophilic-lipophilic balance (HLB) number from 8 to 16. More specifically, the HLB number of each of said polyethoxylated non-ionic surfactants from 9.1 to 15.2.

In an eighth embodiment, the germ-repellent elastomer exhibits a greater than 90 percent reduction in the formation of surface bacteria colonies. More specifically, the bacteria of the surface bacteria colonies being reduced by greater than 90 percent by the germ-repellent elastomer comprise E. coli and S. aureus.

In a nineth embodiment, the germ-repellent elastomer exhibits a greater than 80 percent biocompatibility with living cells. More specifically, the living cells comprise fibroblast cells.

In a tenth embodiment, the germ-repelling modifier is in an amount of approximately 1 to 5 wt. % to the weight of the base polymer. Alternatively or more specifically, the germ-repelling modifier of the present invention is in a range of 2.5 to 5 phr.

In an eleventh embodiment, the polyethylene glycol or the derivative thereof comprises PEG 200, PEG 400, mPEG 600, and poly(ethylene glycol) sorbitol hexaoleate.

In a twelveth embodiment, said isocyanate is a modified methoxy polyethylene glycol formed by coupling methoxyl polyethylene glycol with isophorone diisocyanate to become a highly hydrophilic methoxyl polyethylene glycol represented by the following formula:

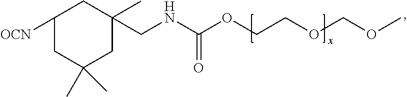

wherein x is an integer from 7 to 10.

In a thirteenth embodiment, said allyoxy group is represented by one of the following formulae:

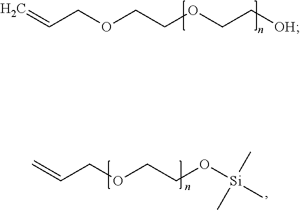

wherein n is an integer from 5 to 12

In a fourteenth embodiment, said siloxane is represented by the following formula:

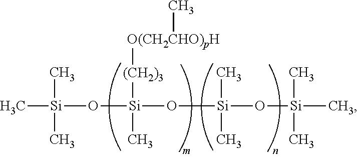

wherein sum of m and n is equal to a value resulting in a molecular weight of the siloxane from 5,000 to 7,000 Da.

In a fifteenth embodiment, the polyether modified silicone is represented by the following formula:

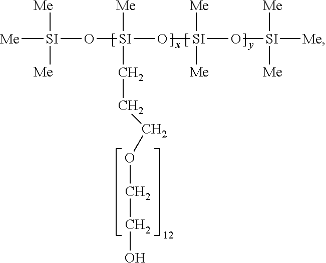

wherein ratio of x:y is about 1:3-5, or sum of x and y is equal to a hydrophilic-lipophilic balance number thereof, wherein the hydrophilic-lipophilic balance number is 12.

In a sixteenth embodiment, the polysorbates are represented by the following formula:

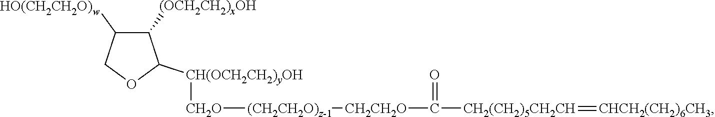

wherein sum of w, x, y and z is 20.

In a seventeenth embodiment, the alcohol ethoxylate is represented by the following formula:

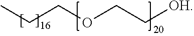

A second aspect of the present invention provides an article containing the present germ-repellent elastomer. Examples of the article include food package, food processor, wearables, textile, garment, footwear, etc.

This Summary is intended to provide an overview of the present invention and is not intended to provide an exclusive or exhaustive explanation.

### BRIEF DESCRIPTION OF THE DRAWINGS

FIG. 1 shows a series of pictures of agar plates depicting bacteria colonies (E. coli and S. aureus) retrieved from the plastic surfaces of control (Pellethane 2363-80AE), TPU-1 and TPU-2 after an incubation period of 24 hours. Note the colonies formation unit (CFU) in the control for E. coli and S. aureus are in the order of 3 and 4 log respectively;

FIG. 2 shows cell viability of L929 cell line towards extracts of TPU-1 and TPU-2 according to certain embodiments of the present invention;

FIG. 3 shows a series of pictures of agar plates depicting bacteria colonies (E. coli and S. aureus) retrieved from the plastic surfaces of control (Elastollan 1185 A), TPU-3 and TPU-4 after an incubation period of 24 hours. Note the CFU in the control for E. coli and S. aureus are both in the order of 4 logs;

FIG. 4 shows a series of pictures of agar plates depicting bacteria colonies (E. coli and S. aureus) retrieved from the plastic surfaces of SEBS control (Elastron P.G401.A45.N), SEBS-1 and SEBS-2 after an incubation period of 24 hours.

FIG. 5 shows a series of pictures of agar plates depicting bacteria colonies (E. coli and S. aureus) retrieved from the plastic surfaces of SEBS control (Kraiburg TM6MED 56A) and SEBS-3 after an incubation period of 24 hours. Note the CFU in the control for E. coli and S. aureus are both in the order of 4 logs;

FIG. 6 shows cell viability of L929 cell line towards extracts of SEBS-1 and SEBS-2 according to certain embodiments of the present invention;

FIG. 7 shows the appearance of unmodified Sylgard 184 and the OFX-0193 modified samples according to certain embodiments of the present invention;

FIG. 8 shows a series of pictures of agar plates depicting bacteria colonies (E. coli and S. aureus) retrieved from the plastic surfaces of the control (Sylgard 184) and S6 after an incubation period of 24 hours. Note the CFU in the control for E. coli and S. aureus are in the order of 3 and 5 logs respectively;

FIG. 9 shows a series of pictures of agar plates depicting bacteria colonies (E. coli and S. aureus) retrieved from the plastic surfaces of the control (LSR2060) and L3-L6 after an incubation period of 24 hours. Note the CFU in the control for E. coli and S. aureus are in the order of 4 and 5 logs respectively;

FIG. 10 shows cell viability of L929 cell line towards the extract of L4 according to certain embodiments of the present invention;

FIG. 11 shows a series of pictures of agar plates depicting bacteria colonies (E. coli and S. aureus) retrieved from the plastic surfaces of the HCR control (Elastosil R401/70), L4 and L6 after an incubation period of 24 hours. Note the CFU in the control for E. coli and S. aureus are in the order of 3 and 4 logs respectively.

### DETAILED DESCRIPTION OF INVENTION

The present invention is not to be limited in scope by any of the following descriptions. The following examples or embodiments are presented for exemplification only.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### Definitions

The singular forms “a,”, “an” and “the” can include plural referents unless the context clearly dictates otherwise.

The term “about” can allow for a degree of variability in a value or range, for example, within 10%, or within 5% of a stated value or of a stated limit of a range.

The term “independently selected from” refers to referenced groups being the same, different, or a mixture thereof, unless the context clearly indicates otherwise. Thus, under this definition, the phrase “X1, X2, and X3 are independently selected from noble gases” would include the scenario where, for example, X1, X2, and X3 are all the same, where X1, X2, and X3 are all different, where X1 and X2 are the same but X3 is different, and other analogous permutations.

The term “phr” defines as the per hundred rubber, which refers to the compound ingredients given as parts per 100 unit mass of the rubber polymer, which is prevalently referred as the polymeric base resin.

### DESCRIPTION

The following examples accompanied with drawings will illustrate the present invention in more detail.

### Examples

Selection of Polymer Base Resin

Among the different classes of commercial TPE, the following base materials listed in Table 1 were used

TABLE 1
Types of TPE base materials studied

| Type | Model | Manufacturer |
|---|---|---|
| SEBS | Elastron P.G401.A45.N | Elastron |
| SEBS | TM6MED 56A | Kraiburg |
| TPU | Elastollan 1185 A 10 FC | BASF Polyurethanes GmbH |
| TPU | Pellethane 2363-80AE | Lubrizol |

Elastron P.G401.A45.N is a soft medical grade SEBS block copolymer based TPE. It provides resistance to oxidation, impact, aging, detergent, acid, bases, bacterial attack and fungus growth. It's selected for development due to its potential for food contact and medical applications. Kraiburg TM6MED 56A is another medical grade SEBS suitable for medical application. Examples of application for SEBS are flexible connection, seals, soft grip, mouthpiece, etc.

Elastollan 1185 A 10 FC is a food contact grade TPU for FDA and EU-regulated markets. The polyether base shows good hydrolysis resistance and high resistance to microorganisms. The building-in of the germ repellent structure would be onto the urethane backbone. It is chosen for initial development of TPU in the study. Per specification, this FC-grade TPU material can also be applied to medical applications, provided that additional biocompatibility tests could be fulfilled. Pellethane 2363-80AE is a medical grade TPU polymer. Germ-repellent properties are demonstrated on this group of TPU to widen the applicability in medical and healthcare applications and still meeting stringent biocompatibility requirements.

Selection of Germ-Repellent Modifier

To achieve the functional performance of TPU and SEBS, the following modifying compounds have been selected for compounding with the base materials (Table 2).

TABLE 2
Modifiers used for compounding

| Modifiers | Details | Manufacturer |
|---|---|---|
| PEG-SHO | Poly(ethylene glycol) sorbitol | Sigma-Aldrich |
| | hexaoleate | |
| Eumulgin B2 | Ceteareth-20 | BASF |
| IPDI-mPEG350 | Isophorone diisocyanate | Synthesized using |
| | methoxypolyethylene glycol | an in-house method |

Poly(ethylene glycol) sorbitol hexaoleate (PEG-SHO) is a non-ionic, semi-natural surfactant commonly used as an emulsion stabilizer for a number of cleaning detergent, cosmetic and pharmacological applications. PEG-SHO is composed of branched PEG segments and ester groups represented by the following formula:

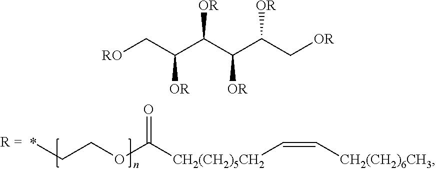

where n can be 1-100, making it a potential candidate for both plasticizer and bacterial repellency with linear PEG. PEG-SHO has a HLB number of 10.0.

Eumulgin® B2 is an alcohol ethoxylate represented by the following formula:

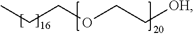

which can be formed by reacting natural fatty alcohol with ethylene oxide via an ether linkage. The more ethylene oxide groups are added to the fatty alcohol, the higher is the hydrophilicity. It is a non-ionic emulsifier useful for the manufacture of cosmetic oil-in-water emulsions. Eumulgin® B2 has a HLB number of 15.2.

The modifier, IPDI-mPEG350 represented by the following formula:

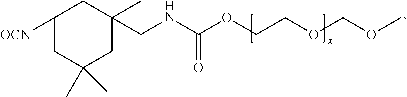

wherein x can be an integer from 7 to 10, is synthesized in-house. The methoxy poly(ethylene glycol)-350 (mPEG-350) is coupled with isophorone diisocyanate (IPDI). This is to impart hydrophilicity in the molecule. The free isocyanate in the molecule can graft onto TPU during reactive extrusion. IPDI-mPEG350 has a HLB number of 19.3

Compounding of the Germ-Repellent Modified Resin

The main process for manufacturing of the formulations is through in-house extrusion. The TPE base resins were dried in the oven at 80° C. overnight to minimize the moisture content as moisture absorption into the samples can potentially lead to degradation and defects in later processing and analysis. Resins were then weighed out in zip-lock bag. Specific concentration of modifier was added to the base. After thorough mixing, the blend is then fed into the twin-screw extruder for compounding. Under the heat and compression by the co-rotating screw, the base resin and modifiers are mixed and compounded into polymer melt. Any typical twin-screw extruder or other extruder capable of compounding the present material can be used. With the low softening temperature, the TPE were processed at temperature ranges from 165° C. to 190° C. Screw speed and feeder speed were set at 150 rpm and 75 rpm respectively. Table 3 shows our extrusion processing condition.

TABLE 3
Processing condition for the extrusion of TPE

| | | | | | | Processing speed | |
|---|---|---|---|---|---|---|---|
| Temperature in extruder | | | | | | Screw | |
| Zone 1 | Zone 2 | Zone 3 | Zone 4 | Zone 5 | Zone 6 | speed | Feeder |
| 165° C. | 170° C. | 175° C. | 180° C. | 185° C. | 190° C. | 150 rpm | 75 rpm |

After extrusion, the extrudate leaving the die is then pelletized. An underwater pelletizer is connected to the die head at extruder end to cut the melt into pellets under water and simultaneously cool the pellets down with the cooling water cycle. The pellets are then separated from the water and dried via a cyclone with compressed air flow. Pellets are eventually dropped down to the collector. With the TPE soft plastics characteristics, it is necessary to cut the extrudate in molten form into pellets and immediately dry with cooling water. Table 4 shows the operating conditions of the underwater pelletizer. The die plate and diverter valve are set at 200° C. (i.e. about 10% above the temperature leaving the extruder die head). This is to ensure the extrudate maintains in molten form for pelletizing. The underwater pelletizer offers a high pelletizing speed, ranges from 1100 rpm onwards. The pelletizing speed is set at 1400 rpm for generating pellets in suitable size for processing. Cooling water cycle remains at around 20° C. throughout the process for cooling the pellets.

TABLE 4
Underwater pelletizer process conditions

| Diverter valve | Die plate | Pelletizing speed | Cooling water |
|---|---|---|---|
| 200° C. | 200° C. | 1400 rpm | 20° C. |

After collecting the pellets, they are dried overnight at 60° C. before being thermoformed into plastic sheets at 160° C. by hot-pressing. The TPE sheet would be for later processing and testing e.g. food contact, mechanical and cytotoxicity etc.

Germ-Repellent Thermoplastic Polyurethane (TPU) Elastomer

Four germ-repellent TPUs (TPU-1-TPU-4) have been developed from two types of TPU base resin: Pellethane 2363-80AE and Elastollan 1185 A 10 FC.

Germ-Repellent TPU from Pellethane 2363-80AE

Pellethane 2363-80AE is a thermoplastic polyurethane elastomer for medical applications. With its elasticity and superior biocompatibility, this type of TPU has found frequent use in wearables and bags that has frequent contact with skin, as well as in the medical sector, e.g. blood bags.

Two germ-repellent TPU formulations (TPU-1 and TPU-2) have been developed using Pellethane. The urethane group throughout the TPU polymer backbone can be linked with the modifiers through the isocyanate moiety (TPU-1) or through the unsaturated double bonds (TPU-2) during reactive extrusion. Table 5 shows the formulations based on Pellethane 2363-80AE.

TABLE 5
Formulation matrix for GR-TPU based on Pellethane 2363-80AE

| | Base Resin | Modifiers (phr) | |
|---|---|---|---|
| | Pellethane | IPDI- | PEG- |
| | 2363-80AE | mPEG-350 | SHO |
| TPU-1 | 100 | 5.0 | — |
| TPU-2 | 100 | — | 5.0 |

The germ-repelling modifier for TPU-1 is IPDI-mPEG350. It was synthesized by reacting isophorone diisocyanate (IPDI) containing a reactive isocyanate group with methoxy poly(ethylene glycol)-350 (mPEG-350). The synthesis is as following: mPEG350 (100 g) was vacuum dried at 120° C. for 4 hours. After cooling down to room temperature, IPDI (1.1 equiv., 69 g) was added slowly. A catalytic amount (2 drops) of dibutyltin dilaurate was added to the mixture. The solution was heated to 90° C. for 2 hr to obtain the modifier which is ready for use without purification. For TPU-2, the germ-repelling modifier is poly(ethylene glycol) sorbitol hexaoleate (PEG-SHO) which is commercially available.

Germ-Repellent Efficacy for TPU-1 and TPU-2

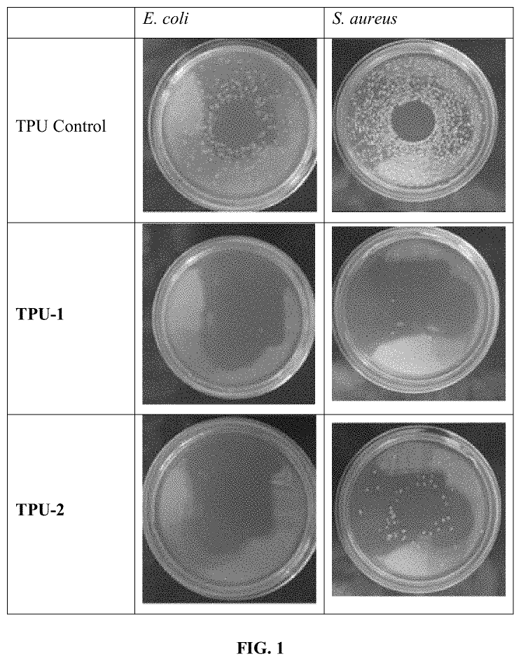

Swab tests have been performed on plastic surface of control, TPU-1 and TPU-2. Three samples from each formulation were tested. The modified TPU-1 and TPU-2 containing the germ-repelling polyoxyethylene groups have shown promising germ-repellency (up to 99% bacterial reduction) towards both E. coli and S. aureus (See Table 6). FIG. 1 shows the examples of agar plates containing bacterial colonies of E. coli and S. aureus with different samples after incubating for 24 hours.

TABLE 6
Relative reduction of E. coli and S. aureus colonies
from swab tests of control, TPU-1 and TPU-2

| | E. coli | S. aureus |
|---|---|---|
| TPU-1 | −99% | −99% |
| TPU-2 | −90% | −99% |

Cytotoxicity of TPU-1 and TPU-2

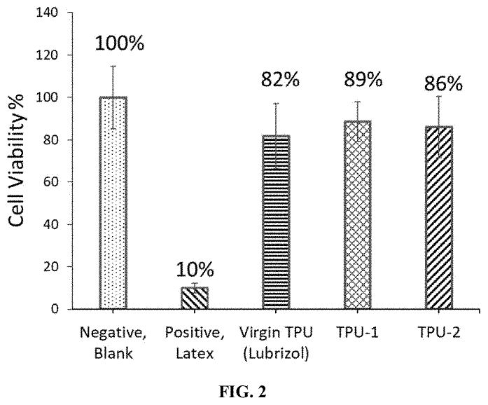

MTT assays were performed on TPU-1, TPU-2 and also on the base resin as demonstrated in FIG. 2. Cell viability of L929 cell lines are 89% and 86% respectively for TPU-1 and TPU-2, slightly higher than 82% for the base resin. Latex was used as the positive control which showed 10% cell viability. This data suggests the modified germ-repellent TPU material has good biocompatibility with living cells.

Germ-Repellent TPU from Elastollan 1185A

Elastollan 1185 A 10 FC is a polyether based TPU with excellent resistance to hydrolysis, high tensile strength and good wear performance. IPDI-mPEG-350 was used as the germ-repellent modifier. TPU-3 and TPU-4 contain 5 phr and 2.5 phr of the modifier respectively. Formulations based on Elastollan 1185 A 10 FC are shown in Table 7.

TABLE 7
Formulation matrix for GR-TPU based
on Elastollan 1185 A 10 FC

| | Base Resin | Modifiers (phr) |
|---|---|---|
| | Elastollan 1185 A 10 FC | IPDI-mPEG-350 |
| TPU-3 | 100 | 5.0 |
| TPU-4 | 100 | 2.5 |

Germ-Repellent Efficacy for TPU-3 and TPU-4

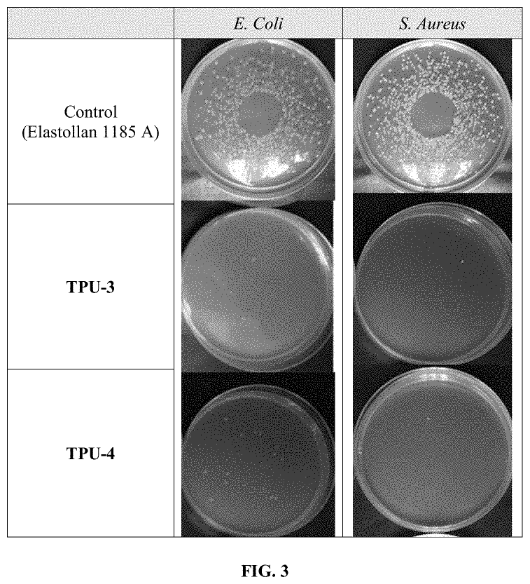

Both TPU-3 and TPU-4 containing different loadings (5.0 phr and 2.5 phr respectively) of the germ-repelling polyoxyethylene groups in IPDI-mPEG-350 show excellent germ-repellency (up to bacterial reductions of 99+%) towards both S. aureus and E. coli (Table 8) after counting the colonies forming units (CFU) on culture plates (FIG. 3).

TABLE 8
Relative reduction of E. coli andS. aureus colonies
from swab tests of control, TPU-3 and TPU-4

| | E. Coli | S. aureus |
|---|---|---|
| TPU-3 | −99+% | −99+% |
| TPU-4 | −98% | −99+% |

Mechanical Properties of Germ-Repellent TPU

The following physical properties (1) Hardness; (2) Density; (3) Tensile strength; (4) Elongation; (5) Tear strength; (6) Compression set, were determined for the selected GR-modified TPU (TPU-1 and TPU-3) and the corresponding unmodified controls (Table 9). All parameters of the formulations and the unmodified control have been determined under the same laboratory condition and according to the ASTM standard. The mechanical properties parameters of both GR formulations are within 20% of the unmodified control, except the tensile strength for TPU-3 being 38.5 N/mm² is +144% with respect to that of the unmodified control (15.8 N/mm²). The increase in tensile strength in TPU-3 could suggest some degree of cross-linking between the modifier and the TPU backbone.

TABLE 9
Mechanical properties of TPU-1 and TPU-3 and the respective
control determined under the same laboratory condition.

| | | Control | TPU-1 | | Control | TPU-3 | |
|---|---|---|---|---|---|---|---|
| | | Pellethane | 5 phr IPDI- | | Elastollan | 5 phr IPDI- | |
| | | 2363 80AE | mPEG350 | | 1185A 10FC | mPEG350 | |
| Shore | ASTM D2240 | 82A | 83A | | 85A | 82A | |
| Hardness | | | | | | | |
| Specific gravity | ASTM D792 | 1.1 | 1.08 | | 1.12 | 1.11 | |
| (g/cm³) | | | | | | | |
| Tensile | ASTM D412 | 24.5 | 23.1 | (−6%) | 15.8 | 38.5 | (+144%) |
| strength | | | | | | | |
| (N/mm²) | | | | | | | |
| (Die C) | | | | | | | |
| Elongation | | 912% | 1065% | (+17%) | 800% | 835% | (+4%) |
| (% at break) | | | | | | | |
| Tear strength | ASTM D624 | 64.0 | 74.4 | (+16%) | 68.2 | 62.4 | (−9%) |
| (N/mm) (Die C) | | | | | | | |
| Compression | ASTM D395 | 32% | 37% | (+16%) | 28% | 29% | (+4%) |
| set (%) (22 h at | | 74% | 70% | (−5%) | 66% | 75% | (+14%) |
| 23° C.; 22 h at | | | | | | | |
| 70° C.) | | | | | | | |

Germ-Repellent Modification of Thermoplastic Elastomers (TPE)

Thermoplastic elastomers based on SEBS (Styrene Ethylene Butylene Styrene) have excellent flexibility and hot-melt processability. As example, germ-repellent SEBS-1 and SEBS-2 have been developed from Elastron P.G401.A45.N, respectively.

Germ-Repellent SEBS

The germ-repellent modifiers used for SEBS based on Elastron P.G401.A45.N and Kraiburg TM6MED 56A are PEG-SHO and B2 as listed in Table 10.

TABLE 10
Formulation matrix for GR-SEBS

| | Base Resin | | | |
|---|---|---|---|---|
| | Elastron | Kraiburg | Modifiers (phr) | |
| | P.G401.A45.N | TM6MED 56A | PEG-SHO | B2 |
| SEBS-1 | 100 | — | 5.0 | — |
| SEBS-2 | 100 | — | — | 5.0 |
| SEBS-3 | — | 100 | — | 5.0 |

Germ-Repellent Efficacy for SEBS-1-SEBS-3

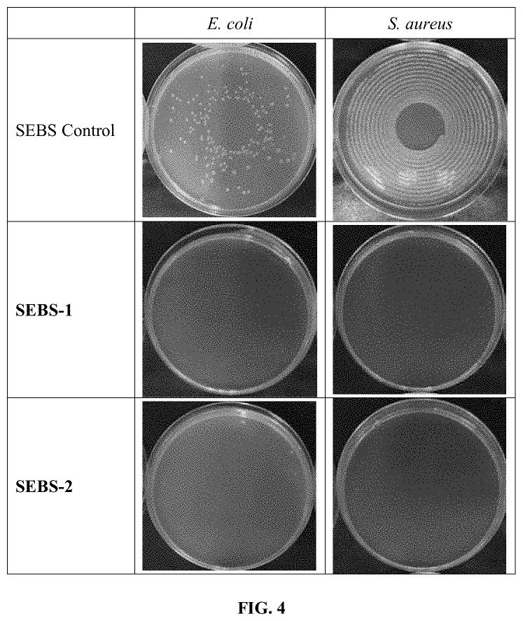

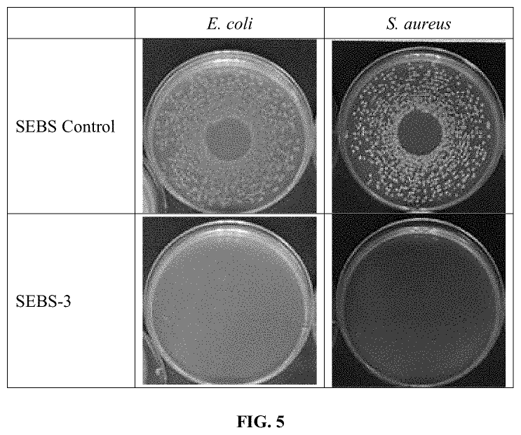

The modified formulations of SEBS show excellent germ-repellent actions after being challenged against both E. coli and S. aureus. As shown in Table 11, more than 1 log reduction in the CFU for both of the formulation can be readily achieved as determined by counting the colonies forming units on culture plates (FIGS. 4 and 5).

TABLE 11
Germ-repellency of SEBS-1-SEBS-3
towards E. Coli and S. aureus

| | E. coli | S. aureus |
|---|---|---|
| SEBS-1 | −99+% | −99+% |
| SEBS-2 | −99+% | −99+% |
| SEBS-3 | −99+% | −99+% |

Cytotoxicity of SEBS-1 and SEBS-2

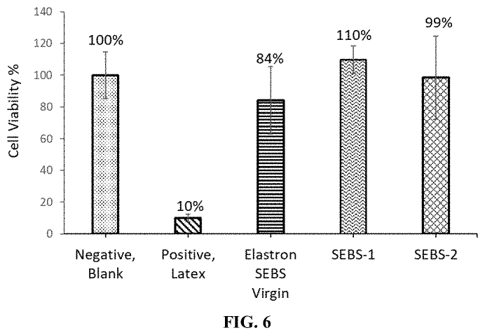

MTT assays were performed on SEBS-1 and SEBS-2 and also on the base resin as shown in FIG. 6. Excellent biocompatibility is observed with SEBS-1 and SEBS-2 with cell viability of L929 cell lines up to 100% and 99% respectively, with the cell viability higher than that of the base resin (84%). This data suggests the modified germ-repellent SEBS material has good biocompatibility with living cells.

Mechanical Properties of Germ-Repellent SEBS

The following physical properties (1) Hardness; (2) Density; (3) Tensile strength; (4) Elongation; (5) Tear strength; (6) Compression set, were determined for the selected GR-modified SEBS (SEBS-2 and SEBS-3) and the corresponding unmodified controls (Table 12). All parameters of the formulations and the unmodified control have been determined under the same laboratory condition and according to the ASTM standard. Except the tensile strength and elongation (% at break) of SEBS-3 are 6.3 N/mm² and 1197% respectively, being +110% and +84% with respect to the values of the unmodified control (3.0 N/mm² and 650%), the mechanical properties parameters of all GR formulations are within 20% of the unmodified control.

TABLE 12
Mechanical properties of SEBS-2 and SEBS-3 and the respective
control determined under the same laboratory condition.

| | | Control | | | Control | | |
|---|---|---|---|---|---|---|---|
| | | Elastron | SEBS-2 | | Kraiburg | SEBS-3 | |
| | | P.G401.A45.N | 5 phr B2 | | TM6MED | 5 phr B2 | |
| Shore | ASTM | 45A | 44A | (−2%) | 56A | 59A | (+5%) |
| Hardness | D2240 | | | | | | |
| Specific | ASTM | 0.89 | 0.945 | (+6%) | 0.89 | 0.895 | (+0.5%) |
| gravity | D792 | | | | | | |
| (g/cm³) | | | | | | | |
| Tensile | ASTM | 3.1 | 3.0 | (−3%) | 3.0 | 6.3 | (+110%) |
| strength | D412 | | | | | | |
| (N/mm²) | | | | | | | |
| (Die C) | | | | | | | |
| Elongation | | 709% | 800% | (+13%) | 650% | 1197% | (+84%) |
| (% at break) | | | | | | | |
| Tear | ASTM | 14.4 | 15.9 | (+10%) | 22.7 | 21.2 | (−7%) |
| strength | D624 | | | | | | |
| (N/mm) | | | | | | | |
| (Die C) | | | | | | | |
| Compression | ASTM | 15% | 17% | (+13%) | 22% | 24% | (+9%) |
| set (%) (22 | D395 | 31% | 37% | (+19%) | 36% | 41% | (+14%) |
| h at 23° C.; | | | | | | | |
| 22 h at 70° C.) | | | | | | | |

Germ-Repellent Silicone

Silicone is one of the most versatile thermoset polymers for medical and food-grade applications due to its highly inert chemistry and strong silicon-oxygen bonding. Herein, two major kinds of silicone resins have been investigated, namely platinum-cured liquid silicone rubber (LSR) and peroxide-cured high consistency rubber (HCR). The following models were selected for this study (Table 13):

TABLE 13
Material list for silicone rubber

| Liquid Silicone Rubber (LSR) | High Consistency Rubber (HCR) |
|---|---|
| Sylgard 184 (Dow Corning) | Cenusil R270 (Wacker) |
| Silopren LSR2060 (Momentive) | Elastosil R401/70 (Wacker) |

To impart germ-repellent properties into the silicone rubber, different modifiers were incorporated into the base materials (LSR and HCR). The effective modifiers can be polyethylene glycol (PEG), polypropylene glycol (PPG), PEG or PPG terminated, or copolymers with side chains of PEG or PPG groups, as indicated in Table 14.

TABLE 14
Material list for additives to be used for modifying silicone

| Name | Brand | Chemical Formula | HLB Number |
|---|---|---|---|
| ENEA-0260 Allyloxy(polyethylene)oxide | Gelest | 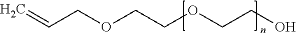 | 5-8 |
| CMS-222 (Hydroxypropyleneyl) methylsiloxane-dimethyl siloxane copolymer | Gelest | 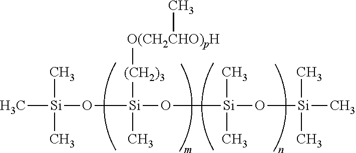 | 1.5 |
| SIA0479.0 O-allyloxy(polyetheneoxy) trimethylsilane | Gelest | 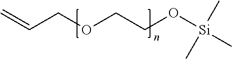 | N/A |
| OFX-0193 silicone polyether copolymer | Dow Corning | 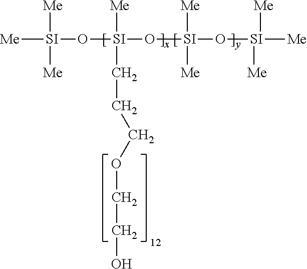 | 12.2 |
| PEG 200 Polyethylene glycol, Mw.200 | Kermel_Tianjing | 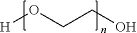 | 9.1 |
| PEG 400 Polyethylene glycol, Mw.400 | Kermel_Tianjing | 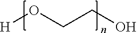 | 12.9-13.1 |
| mPEG 600 Methyl polyethylene glycol, Mw.600 | Chenrun_Nantong | 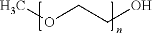 | 19.5 |
| TWEEN ® 80 Polyoxyethylenesorbitan monooleate | Sigma | 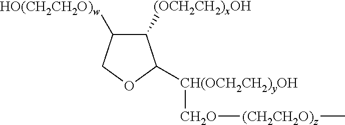 | 15 |
| | | Sum of w + x + y + z | |

The difference between HCR and LSR lies on their viscosities and hence different processing procedures are used to prepare samples of each type. LSR is generally in the form of part A and part B. The two parts are mixed and heat cured in the presence of platinum curing agent. LSR can be applied to extrusion or injection molded products, examples are sealants, O-rings, tubing, baby bottle nipples, small medical inserts, etc. HCR generally exists in a gum form. It can be heat-cured in the presence of peroxide curing agents. HCR can be compression-molded into desired shapes, or extruded into calendered sheets for mold-cutting into e.g. sealants, culinary mats and containers, etc.

Preparation of Germ-Repellent Silicone

The germ repellent silicone (LSR) sample could be prepared by separately weighing Part A (hydride-rich polydimethylsiloxane oligomers) and Part B (vinyl-rich polydimethylsiloxane oligomers) of LSR system into a clean plastic cup. Then specific amounts of modifier in phr are added into the same cup. As an example, in the preparation of L4 (LSR2060/5 phr ENEA-0260), 25 g of Part A, 25 g of Part B and 2.5 g of ENEA-0260 were weighed into a clean cup. A high-speed mixer operating at 2000 rpm for 5 mins was used for the mixing. The mixing could also be accomplished in a liquid injection molding (LIM) machine, where the LSR and the liquid modifier could be fed into and mixed in the injection screw as a single mixing step. After mixing, a hot-press preheated to 175° C. was used to partially cure and to simultaneously thermoform the LSR into sheets. The samples were then post-cured for 4 hours in an oven, at a regulated temperature between 175° C.-200° C. to ensure the silicone samples are fully cured and to remove any remaining volatile organic matters. The sheets were cut into desired 4 cm×4 cm plastic sheet for germ-repellency evaluation or die-cut into sample specimens according to the relevant ASTM standard for mechanical properties determination.

For germ-repellent HCR, H4 as an example, 1 kg of HCR gum and 1% (10 g) of silicone gel containing a peroxide-based curing agent, 2,5-dimethyl-2,5-di(tert-butylperoxy)hexane, are weighed and kneaded in a two-roll mill. The gum softens as it is being kneaded but no curing occurs at this step. Then 5 phr (i.e. 50 g) of the modifier, ENEA-0260, was added gradually and into the softened silicone using a plastic pipette. Aliquots were added in multiple phases to avoid slipping the silicone from the roll drum. The heterogeneous silicone would feel sticky to the hands. With repeated compressing and folding cycles in the two roll-mill, sufficient mixing of the germ-repellent modifier could be achieved as apparent from the non-sticky characteristic of the well-mixed silicone gum. Then 300-400 g of the well-mixed silicone gum was cured and pressed into either sheets using compression molds at 180° C. for 2-3 minutes at a mold pressure of 2-3 MPa. The GR modified HCR silicone sheets were post-cured for 4 hours at 200° C. to ensure the silicone samples were fully cured and free of remaining volatile organic matters. The sheets were cut into desired 4 cm×4 cm plastic sheet for germ-repellency evaluation or die-cut into sample specimens according to the relevant ASTM standard for mechanical properties determination. The thermoforming conditions employed for the silicone are summarized in Table 15.

TABLE 15
Curing condition for silicone rubbers

| | Liquid Silicone Rubber (LSR) | | High Consistency Rubber (HCR) | |
|---|---|---|---|---|
| Model | Sylgard 184 | LSR2060 | Cenusil R 270 | Elastosil R401/70 |
| Curing | Platinum | Platinum | Peroxide | Peroxide |
| agent | cured | cured | cured | cured |
| Curing | 1^{st} Curing | 1^{st} Curing | 1^{st} Curing | 1^{st} Curing |
| temperature | 60° C., oven, | 175° C., hot-press | 175° C., hot-press | 175° C., hot-press |
| | 24 hours | machine, 2 mins; | machine, 2 mins; | machine, 2 mins; |
| | | 2^{nd} Curing | 2^{nd} Curing | 2^{nd} Curing |
| | | 200° C., oven, | 200° C., oven, | 200° C., oven, |
| | | 4 hours | 4 hours | 4 hours |

Germ-Repellent Modification on Sylgard 184

According to our preliminary work in other plastics, PEGs can give an excellent germ-repellent performance. In the initial phase for the evaluation of germ-repellent capacity of silicones, Sylgard 184, which is a low viscosity polydimethylsiloxane (PDMS) and has the merit of easy preparation, was selected for blending with PEGs. Formulations based on Sylgard 184 are shown in Table 16:

TABLE 16
Formulation matrix for Sylgard 184

| | | Modifiers | | | | |
|---|---|---|---|---|---|---|
| | Base Resin | PEG | PEG | | | |
| No. | Sylgard 184 | 200 | 400 | mPEG 600 | OFX-0193 | Tween 80 |
| S1 | 100 | 5 | — | — | — | — |
| S2 | 100 | — | 5 | — | — | — |
| S3 | 100 | — | — | 5 | — | — |
| S4 | 100 | — | — | — | 1 | — |
| S5 | 100 | — | — | — | 3 | — |
| S6 | 100 | — | — | — | 5 | — |
| S7 | 100 | — | — | — | — | 1 |
| S8 | 100 | — | — | — | — | 3 |

Germ-Repellent Efficacy of Modified Sylgard 184

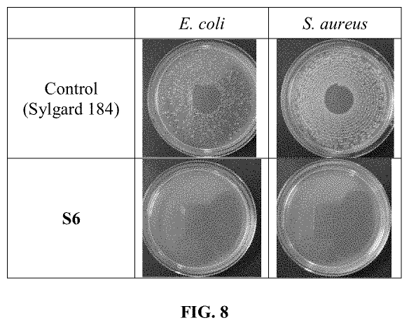

Functional test of the present invention suggested that germ-repellency could be imparted to the low viscosity polydimethylsiloxane Sylgard 184 with the polyethylene glycol-based modifiers. OFX-0193 was demonstrated to be an effective germ-repellent modifier for Sylgard 184, with bacterial reduction of up to 99% against both E. coli and S. aureus (Table 17, entry S5 and S6) as determined by counting the colonies forming units on culture plates (FIG. 8). Germ-repellency against E. coli could also be observed in S2, S3, S7 and S8 with PEG 400, mPEG 600 and Tween 80, with bacterial reduction of up to 100%.

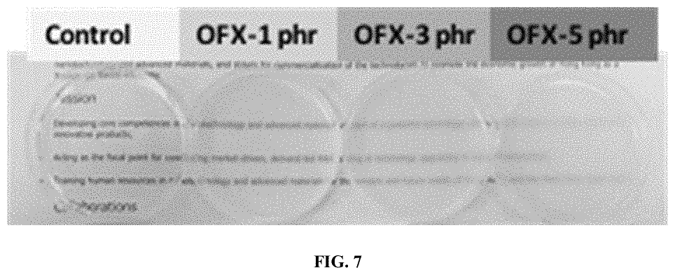

The OFX-0193 modified Sylgard 184 has excellent germ-repellency towards both E. coli and S. aureus; but the PDMS turns increasingly opaque with increasing concentration (FIG. 7). In optimizing the optical property and the germ-repellent efficacy, S5 containing 3 phr of OFX-0193 in Sylgard 184 could represent the optimal choice.

TABLE 17
Relative bacterial colony counts of E. coli and S. aureus from swab tests of
the modified and unmodified Sylgard 184 samples; symbol “+” indicates
an increased number of colonies relative to the control

| | S1 | S2 | S3 | S4 | S5 | S6 | S7 | S8 |
|---|---|---|---|---|---|---|---|---|
| E. coli | + | −100% | −100% | −50% | −99% | −99+% | −100% | −98% |
| S. aureus | + | + | + | −99+% | −99+% | −99+% | −17% | −58% |

Germ-Repellent Modification on LSR2060

OFX-0193 and additional modifiers (ENEA-0260, CMS-222 and SIA0479.0) were selected for germ-repellent modification of LSR2060. All modifiers are derivatives of polyethylene glycol or polypropylene glycol. Table 18 shows the formulations for the modification of LSR2060:

TABLE 18
Formulation for LSR2060; all values are in phr (per hundred rubber)

| | Base | Modifiers | | | |
|---|---|---|---|---|---|
| | Resin | OFX-0193 | ENEA-0260 | CMS-222 | SIA0479.0 |
| No. | LSR2060 | Blend | Reactive | Blend | Reactive |
| Ll | 100 | 5 | — | — | — |
| L2 | 100 | — | 1 | — | — |
| L3 | 100 | — | 3 | — | — |
| L4 | 100 | — | 5 | — | — |
| L5 | 100 | — | — | 5 | — |
| L6 | 100 | — | — | — | 5 |

Germ-Repellent Efficacy of Modified LSR2060

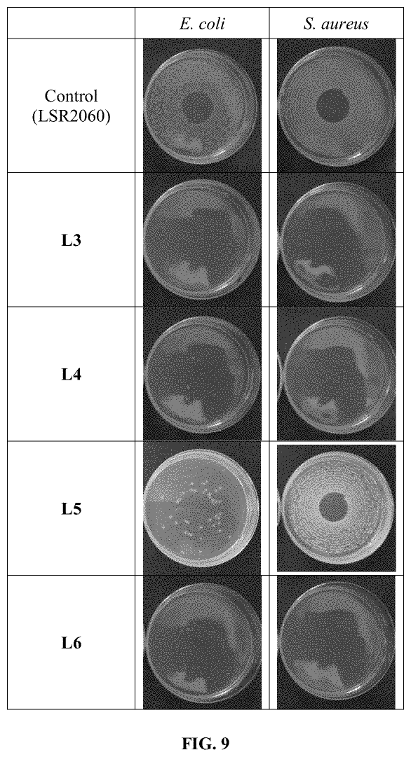

In the experimental matrix, the germ-repellency of LSR2060 with four kinds of polyglycols and silicone copolymers modifiers were evaluated. Formulations with 3 phr or above ENEA-0260 (i.e. L3 and L4) and 5 phr SIA0479.0 (L6) show excellent germ-repellency, with bacterial reduction of up to 100% against both E. coli and S. aureus (Table 19) as determined by counting the colonies forming units on culture plates (FIG. 9). LSR2060 modified with 5 phr CMS-222 (polypropylene glycol-silicone copolymer) as in L5, could also demonstrate germ-repellency with greater than one log reduction (−93%) against E. coli.

TABLE 19
Relative bacterial colony counts of E. coli and S. aureus from swab
tests of the modified and unmodified LSR0260 samples; symbol “+”
indicates an increased number of colonies relative to the control

| | L1 | L2 | L3 | L4 | L5 | L6 |
|---|---|---|---|---|---|---|
| E. coli | −25% | −39% | −100% | −99+% | −93% | −99+% |
| S. aureus | −94% | + | −100% | −100% | + | −100% |

Cytotoxicity of Germ-Repellent Silicone L4

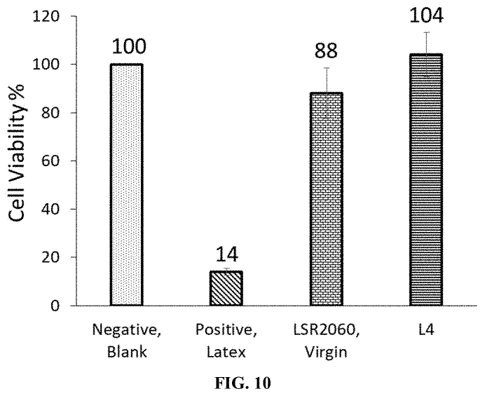

MTT assays were performed on L4 and also on the base material, LSR2060, as shown in FIG. 10. The level of cytotoxicity was evaluated towards the L929 cell line (mouse fibroblast). Excellent biocompatibility is observed with L4 with cell viability of L929 cell lines up to 104%, higher than that of the base material (88%). Latex was used as the positive control which showed 14% cell viability. This data suggests the germ-repellent modified LSR has good biocompatibility with living cells.

Germ-Repellent Modification of HCR

Successful formulations for LSR are experimented in two different models of HCR to assess the feasibility of developing GR HCR. Initial experiments have been conducted at 3 phr for ENEA-0260, 5 phr for CMS-222 and 2 phr for SIA0479.0, as listed in Table 20. These modifier concentrations have been selected based on favorable results from the LSR counterparts. OFX-0193 has not been formulated for HCR as it cannot withstand heating to 200° C. for extended periods. It is observed that germ-repellence efficacy may dependent on the base resin. Cenusil R401 demonstrates germ-repellency effect more readily than the R270 counterpart, which has a hardness of Shore A 70 rather than Shore A 55 in R401. Formulation H5, with a polypropylene glycol-polydimethylsiloxane copolymer (non-polyethylene glycol-based modifier) appears to possess some germ-repellent effect.

TABLE 20
Experimental matrix for formulating GR HCR (in phr units)

| | Base Resin | | | | |
|---|---|---|---|---|---|
| | Cenusil | Elastosil | Modifiers | | |
| No. | R270 | R401/70 | ENEA0260 | CMS-222 | STA 0479.0 |
| H1 | 100 | — | 3 | — | — |
| H2 | 100 | — | — | 5 | — |
| H3 | 100 | — | — | — | 2 |
| H4 | — | 100 | 3 | — | — |
| H5 | — | 100 | — | 5 | — |
| H6 | — | 100 | — | — | 2 |

Germ-Repellent Efficacy of Modified HCR

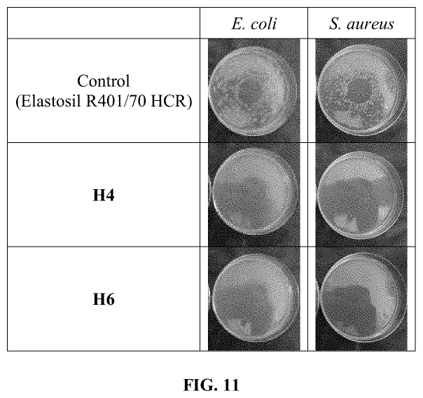

HCR formulations with 3 phr ENEA-0260 (i.e. H1 and H4), 5 phr CMS-222 (i.e. H5) and 2 phr of SIA0479.0 (H6) all show excellent germ-repellency, with bacterial reduction of up to 100% against both E. coli and S. aureus (Table 21) as determined by counting the colonies forming units on culture plates (FIG. 11). Cenusil R270 HCR base resin modified with 5 phr SIA0479.0 as in H3, also demonstrate excellent germ-repellency with greater than one log reduction (−98%) against E. coli.

TABLE 21
Relative bacterial colony counts of E. coli and S. aureus from swab
tests of the modified and unmodified HCR samples; symbol “+”
indicates an increased number of colonies relative to the control

| | H1 | H2 | H3 | H4 | H5 | H6 |
|---|---|---|---|---|---|---|
| E. coli | −100% | −59% | −60% | −100% | −100% | −100% |
| S. aureus | −100% | + | −98% | −100% | −100% | −100% |

Mechanical Properties of Germ-Repellent Silicone

The following physical properties (1) Hardness; (2) Density; (3) Tensile strength; (4) Elongation; (5) Tear strength; (6) Compression set, were determined for the selected GR-modified LSR (L4), GR-modified HCR (H4), and the corresponding unmodified controls (Table 22). All parameters of the formulations and the unmodified control have been determined under the same laboratory condition and according to the ASTM standard. Except the compression set of H4 being 61%, which is +61% compared with the unmodified control (38%), the mechanical properties parameters of both GR formulations, are within 20% of the unmodified control.

TABLE 22
Mechanical properties of L4 and H4 and the respective
control determined under the same laboratory condition

| | | | L4 | | Control | H4 | |
|---|---|---|---|---|---|---|---|
| | | Control | 5 phr ENEA- | | Cenusil | 3 phr ENEA- | |
| | | LSR2060 | 0260 | | R401/70 | 0260 | |
| Shore | ASTM D2240 | 62A | 61A | (−2%) | 72A | 70A | (−3%) |
| Hardness | | | | | | | |
| Specific | ASTM D792 | 1.14 | 1.14 | | 1.19 | 1.19 | |
| gravity | | | | | | | |
| (g/cm³) | | | | | | | |
| Tensile | ASTM D412 | 6.5 | 5.8 | (−11%) | 9.0 | 7.3 | (−19%) |
| strength | | | | | | | |
| (N/mm²) | | | | | | | |
| (Die C) | | | | | | | |
| Elongation | | 445% | 497% | (+12%) | 924% | 1077% | (+17%) |
| (% at break) | | | | | | | |
| Tear | ASTM D624 | 35.5 | 29.9 | (−16%) | 22.5 | 26.3 | (+17%) |
| strength | | | | | | | |
| (N/mm) | | | | | | | |
| (Die C) | | | | | | | |
| Compression | ASTM D395 | 28.6% | 33% | (+15%) | 38% | 61% | (+61%) |
| set (%) | | | | | | | |
| (22 h at 175°) | | | | | | | |

### INDUSTRIAL APPLICABILITY

The present invention is useful in making a germ-repelling article which is non-leaching, non-carcinogenic and non-toxic for the improvement in public health. Furthermore, it is safe for food contact, medical and consumer applications.

1. A germ-repellent elastomer comprising:
a base polymer selected from latex, synthetic rubber, thermoplastic elastomers, or copolymers or mixtures thereof; and
at least one germ-repelling modifier selected from one or more polyethoxylated non-ionic surfactants such that a highly hydrophilic moiety is imparted from the at least one germ-repelling modifier to the base polymer either by physical or reaction extrusion.

2. The germ-repellent elastomer according to claim 1, wherein the base polymer is thermoplastics elastomers.

3. The germ-repellent elastomer according to claim 1, wherein the base polymer is thermoplastics polyurethane.

4. The germ-repellent elastomer according to claim 1, wherein the base polymer is styrene ethylene butylene styrene.

5. The germ-repellent elastomer according to claim 1, wherein the base polymer is liquid silicon rubber.

6. The germ-repellent elastomer according to claim 1, wherein the base polymer is high consistency rubber.

7. The germ-repellent elastomer according to claim 1, wherein the one or more polyethoxylated non-ionic surfactants is/are selected from the group consisting of polyethylene glycol, alcohol ethoxylate, isocyanate, allyoxy group, siloxane, polyether modified silicone, polysorbates, and any derviatives, copolymers, or mixtures thereof.

8. The germ-repellent elastomer according to claim 1, wherein each of the polyethoxylated non-ionic surfactants has a hydrophilic-lipophilic balance number from 8 to 16.

9. The germ-repellent elastomer according to claim 1, wherein the elastomer exhibits a greater than 90 percent reduction in the formation of surface bacteria colonies.

10. The germ-repellent elastomer according to claim 1, wherein the elastomer exhibits a greater than 80 percent biocompatibility with living cells.

11. The germ-repellent elastomer according to claim 1, wherein the at least one germ-repelling modifier is in an amount of approximately 1 to 5 wt. % to the weight of the base polymer.

12. The germ-repellent elastomer according to claim 7, wherein said polyethylene glycol or the derivative thereof comprises PEG 200, PEG 400, mPEG 600, and poly(ethylene glycol) sorbitol hexaoleate.

13. The germ-repellent elastomer according to claim 7, wherein said isocyanate is a modified methoxy polyethylene glycol formed by coupling methoxyl polyethylene glycol with isophorone diisocyanate to become a highly hydrophilic methoxyl polyethylene glycol represented by the following formula: 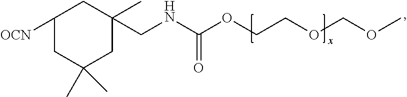
wherein x is an integer from 7 to 10.

14. The germ-repellent elastomer according to claim 1, wherein the at least one germ-repelling modifier is in a concentration from 2.5 to 5 phr.

15. The germ-repellent elastomer according to claim 7, wherein the allyoxy group is represented by one of the following formulae: 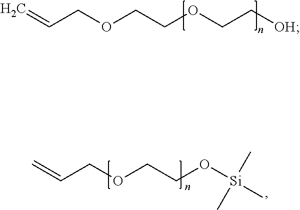
wherein n is an integer from 5 to 12.

16. The germ-repellent elastomer according to claim 7, wherein the siloxane is represented by the following formula: 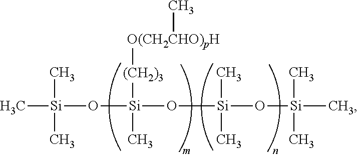
wherein sum of m and n is equal to a value resulting in a molecular weight of the siloxane from 5,000 to 7,000 Da.

17. The germ-repellent elastomer according to claim 7, wherein the polyether modified silicone is represented by the following formula: 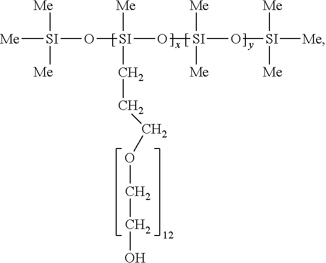
and
wherein ratio of x:y is about 1:3-5, or sum of x and y is equal to a hydrophilic-lipophilic balance number thereof, wherein the hydrophilic-lipophilic balance number is 12.

18. The germ-repellent elastomer according to claim 7, wherein the polysorbates are represented by the following formula: 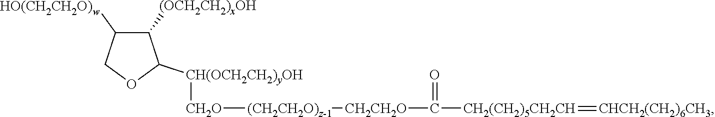
wherein sum of w, x, y and z is 20.

19. The germ-repellent elastomer according to claim 7, wherein the alcohol ethoxylate is represented by the following formula:

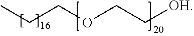

20. The germ-repellent elastomer according to claim 9, wherein the bacteria of the surface bacteria colonies being reduced by greater than 90 percent by the germ-repellent elastomer comprise E. coli and S. aureus.

21. The germ-repellent elastomer according to claim 10, wherein the living cells being biocompatible with said elastomer of greater than 80 percent biocompatibility comprise fibroblast cells.

22. An article containing the germ-repellent elastomer of claim 1.
